(19) United States
(12) Patent Application Publication
(10) Pub. No.: US 2017/0093770 A1
(43) Pub. Date: Mar. 30, 2017

(54) TECHNOLOGIES FOR RECEIVE SIDE MESSAGE INSPECTION AND FILTERING

(71) Applicant: Intel Corporation, Santa Clara, CA (US)

(72) Inventors: Mario Flajslik, Hudson, MA (US); James Dinan, Hudson, MA (US); Keith D. Underwood, Albuquerque, NM (US)

(21) Appl. No.: 14/866,541

(22) Filed: Sep. 25, 2015

(51) Int. Cl. H04L 12/58

(52) U.S. Cl. CPC H04L 51/12

(57) ABSTRACT

Technologies for filtering a received message include a receiving computing device to receive messages and a sender computing device to send messages. The receiving computing device is configured to retrieve a descriptor from a received message and retrieve another descriptor from an inspection entry of a network port entry selected from a network port entry table by the receiving computing device based on the logical network port that received the message. The receiving computing device is further configured to compare the descriptors to determine whether the descriptors match. Upon finding a match, the receiving computing device is still further configured to perform an operation corresponding to the inspection entries whose descriptor matches the descriptor of the message. Other embodiments are described and claimed.

### BACKGROUND

Network operators and communication service providers typically rely on complex, large-scale computing environments, such as parallel and/or distributed computing environments (e.g., high-performance computing (HPC) environments, cloud computing environments, etc.). Due to the complexities associated with such large-scale computing environments, communications (e.g., network traffic, messages, messages, etc.) between the computing devices (i.e., physical or virtual computing devices) of the computing environment typically rely on one or more communications protocol. One such communications protocol is Message Passing Interface (MPI), which is a standardized system for passing messages between compute nodes or processes in parallel computing systems. MPI defines point-to-point message ordering between processes based on the matching criteria of MPI messages to provide virtual topology, synchronization, and communication functionality between the processes in a language-independent fashion (e.g., by using language-specific syntax).

Under certain conditions, such as a source computing device of the computing environment becoming unusable, failed processes can transmit messages via MPI that become stale in transit. As such, the processing of those messages at a destination computing device configured to receive the messages may corrupt a state of one or more processes of the destination computing device. In other words, if messages from a failed process are captured by the destination computing device, an application state of the destination computing device can be compromised when a future receive operation is performed. For example, the messages may never be completely processed by the destination computing device and, as a result, processing can consume resources of the destination computing device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for receive side message inspection filtering that includes one or more sender computing devices communicatively coupled over a network with a receiving computing device;

FIG. 2 is a simplified block diagram of at least one embodiment of the receiving computing device of FIG. 1;

FIG. 3 is a simplified block diagram of at least one embodiment of an environment that may be established by the receiving computing device of the system of FIGS. 1 and 2;

FIG. 4 is a simplified block diagram of at least one embodiment of an implementation of an inspection entry prepended to a set of match list entries; and

FIGS. 5 and 6 are a simplified flow diagram of at least one embodiment of a method for filtering a received message that may be executed by the receiving computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media (e.g., memory, data storage, etc.), which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

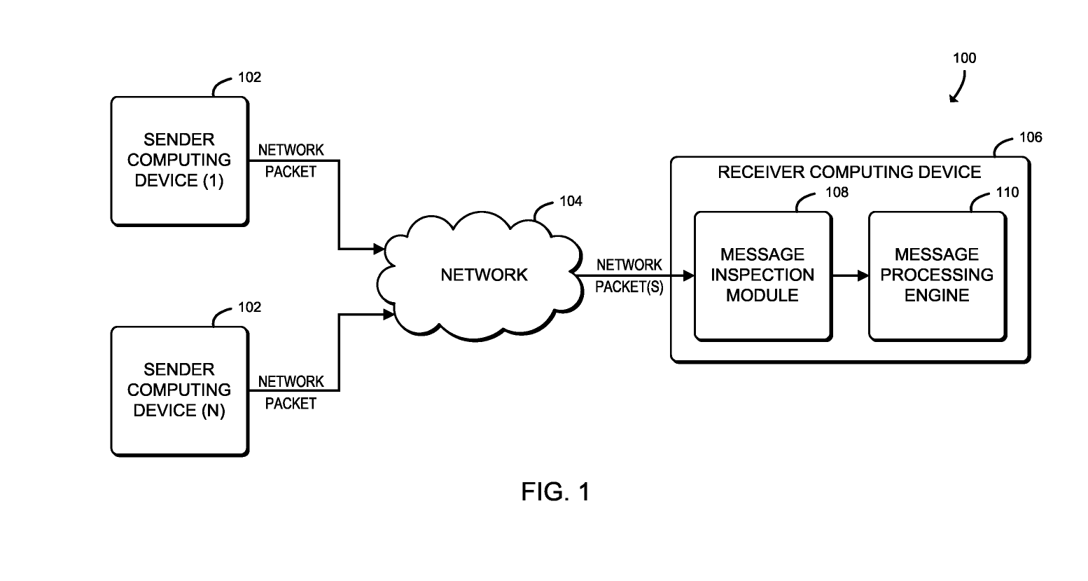

Referring now to FIG. 1, in an illustrative embodiment, a system 100 for inspecting and filtering receive side messages includes one or more sender computing devices 102 and a receiver computing device 106 communicatively coupled over a network 104. In use, the sender computing devices 102 transmit messages (e.g., network communications, network packets, etc.) to the receiver computing device 106, which receives the messages at a message inspection module 108 of the receiver computing device 106. As described in detail below, upon receiving the messages at the message inspection module 108, the message inspection module 108 filters the messages to determine whether the messages should be processed by a message processing engine 110 of the receiver computing device 106. For example, if a process of one of the sender computing devices 102 has failed (e.g., a no longer running application of a failed sender computing device 102, etc.), the receiver computing device 106 should no longer accept and process any messages originating from the failed process.

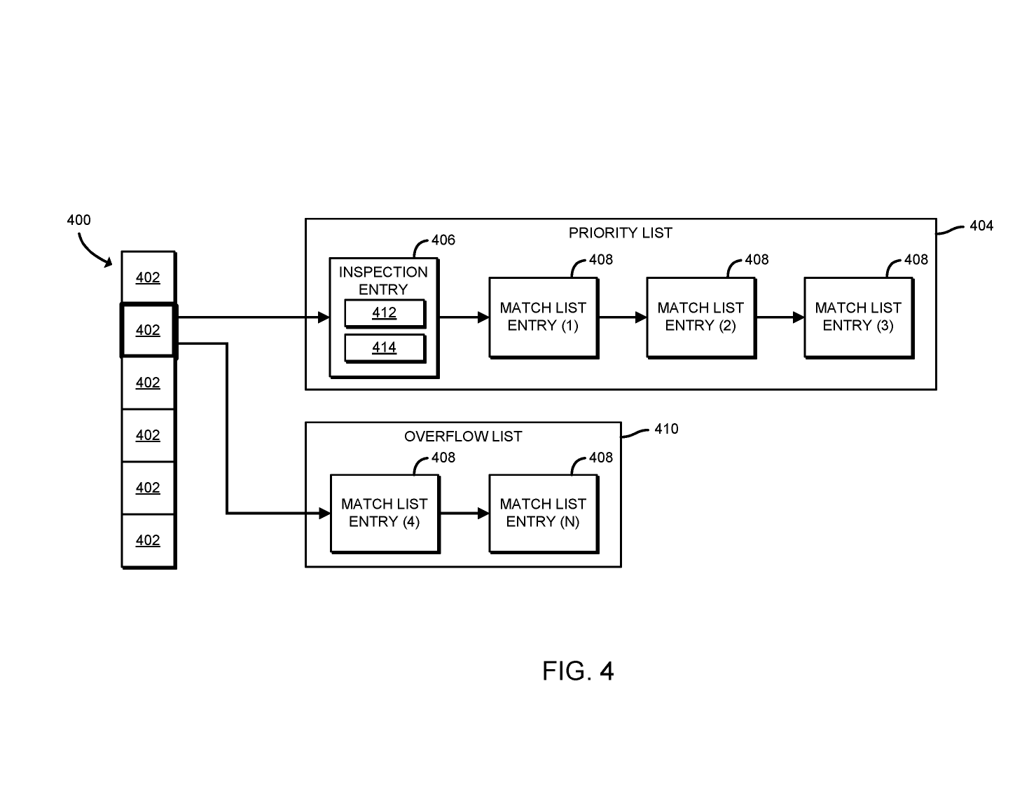

Accordingly, to perform the filtering operation, the message inspection module 108 inspects each message prior to processing of the message by the message processing engine 110. To do so, the message inspection module 108 compares at least a portion of the message to an inspection entry (see, e.g., the inspection entry 406 of FIG. 4) of a network port entry table or other data construct. Upon locating an inspection entry whose description matches the portion of the message compared, an operation associated with the inspection entry may then be performed by the receiver computing device 106. For example, in some embodiments, the message may be dropped or further processed. Additionally or alternatively, a notification may be sent to the sender (e.g., one of the sender computing devices 102) of a status of the message, the message may be logged, etc.

It should be appreciated that, depending on the embodiment, the message processing may be performed in hardware or software. Accordingly, due to the inspection and filtering of the message being performed prior to the message processing, the inspection and filtering may be performed in hardware or software. For example, in such embodiments wherein the message processing is performed in hardware, the message inspection and filtering may also be performed in hardware before any state changes (e.g., before write operations to a memory of the receiver computing device 106 are performed during processing of the message). It should be further appreciated that, in some embodiments, the message inspection module 108 and the message processing engine 110 may be co-located, so long as the message inspection module 108 is configured upstream of the message processing engine 110 such that the message inspection module 108 can intercept messages before the messages are processed by the message processing engine 110.

Each of the sender computing devices 102 may be embodied as any type of computation or computer device capable of performing the functions described herein, including, without limitation, a server (e.g., stand-alone, rack-mounted, blade, etc.), a network appliance (e.g., physical or virtual), a web appliance, a distributed computing system, a processor-based system, a multiprocessor system, a smartphone, a mobile computing device, a tablet computer, a laptop computer, a notebook computer, and/or any other computing/communication device.

The network 104 may be embodied as any type of wired or wireless communication network, including cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), telephony networks, local area networks (LANs) or wide area networks (WANs), global networks (e.g., the Internet), or any combination thereof. Additionally, the network 104 may include any number of may include additional computing devices (i.e., networking devices) (not shown), physical and/or virtual, that may be commonly found in networks, such as servers, switches, routers, access points, network controllers, etc. It should be appreciated that, in some embodiments, the network 104 may be embodied as any type of parallel and/or distributed computing architecture (e.g., a high performance computing (HPC) network architecture) that is capable of high-speed, low-latency interconnectivity, such as a cluster computing network architecture and/or a grid computing network architecture (e.g., a fabric computing network architecture).

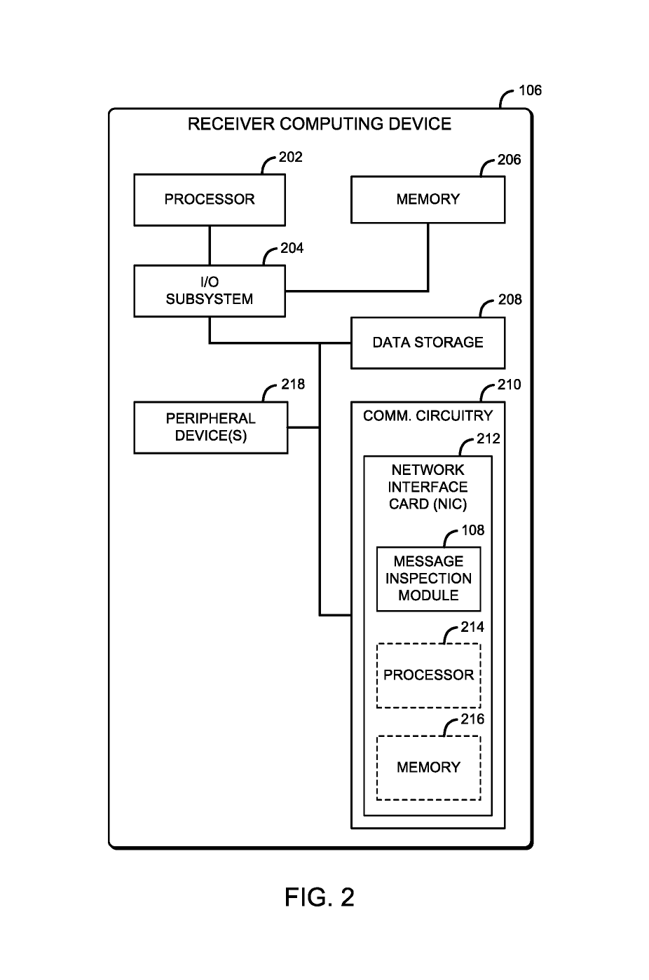

The receiver computing device 106 may be embodied as any type of computation or computer device capable of performing the functions described herein, including, without limitation, a server (e.g., stand-alone, rack-mounted, blade, etc.), a network appliance (e.g., physical or virtual), a web appliance, a distributed computing system, a processor-based system, a multiprocessor system, a smartphone, a mobile computing device, a tablet computer, a laptop computer, a notebook computer, and/or any other computing/communication device. As shown in FIG. 2, the illustrative receiver computing device 106 includes a processor 202, an input/output (I/O) subsystem 204, a memory 206, a data storage device 208, communication circuitry 210, and one or more peripheral devices 218. Of course, the receiver computing device 106 may include other or additional components, such as those commonly found in a server (e.g., various input/output devices), in other embodiments. Additionally, in some embodiments, one or more of the illustrative components may be incorporated in, or otherwise form a portion of, another component. For example, the memory 206, or portions thereof, may be incorporated in the processor 202 in some embodiments. Further, in some embodiments, one or more of the illustrative components may be omitted from the receiver computing device 106 (e.g., the one or more peripheral devices 216).

The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 206 may be embodied as any type of volatile or non-volatile memory or data storage capable of performing the functions described herein. In operation, the memory 206 may store various data and software used during operation of the receiver computing device 106 such as operating systems, applications, programs, libraries, and drivers. The memory 206 is communicatively coupled to the processor 202 via the I/O subsystem 204, which may be embodied as circuitry and/or components to facilitate input/output operations with the processor 202, the memory 206, and other components of the receiver computing device 106. For example, the I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 206, and other components of the receiver computing device 106, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. The data storage device 208 and/or the memory 206 (e.g., the computer-readable storage media) may store various data as described herein, including operating systems, applications, programs, libraries, drivers, instructions, etc., capable of being executed by a processor (e.g., the processor 202) of the receiver computing device 106.

The communication circuitry 210 may be embodied as any communication circuit, device, or collection thereof, capable of enabling communications between the receiver computing device 106 and other remote devices (e.g., the source computing devices 102) over a network (e.g., the network 104). The communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication. In some embodiments, the communication circuitry 210 is configured to perform high-speed communication (e.g., in a high performance compute (HPC) cluster) with other computing devices (e.g., the source computing devices 102).

The illustrative communication circuitry 210 includes a network interface controller (NIC) 212. The NIC 212 may be embodied as one or more add-in-boards, daughtercards, network interface cards, controller chips, chipsets, or other devices that may be used by the receiver computing device 106. For example, in some embodiments, the NIC 212 may be integrated with the processor 202, embodied as an expansion card coupled to the I/O subsystem 204 over an expansion bus (e.g., PCI Express), part of an SoC that includes one or more processors, or included on a multichip package that also contains one or more processors.

Alternatively, in some embodiments, the NIC 212 may include a processor 214 and/or a memory 214 that are local to the NIC 212. In such embodiments, the processor 214 may be capable of performing the offloaded message processing functions as described herein. Additionally or alternatively, in such embodiments, the memory 214 may be capable of storing data locally, such that a state change of the receiver computing device 106 is not affected. Additionally or alternatively, in some embodiments, functionality of the NIC 212 may be integrated into one or more components of the receiver computing device 106 at the board level, socket level, chip level, and/or other levels. The illustrative NIC 212 includes the message inspection module 108. As described previously, the message inspection module 108 may be embodied as hardware circuitry (i.e., as hardware of the NIC 212).

The peripheral devices 218 may include any number of additional peripheral or interface devices, such as speakers, microphones, additional storage devices, and so forth. The particular devices included in the peripheral devices 218 may depend on, for example, the type and/or intended use of the receiver computing device 106. Additionally or alternatively, the peripheral devices 218 may include one or more ports, such as a USB port, for example, for connecting external peripheral devices to the receiver computing device 106.

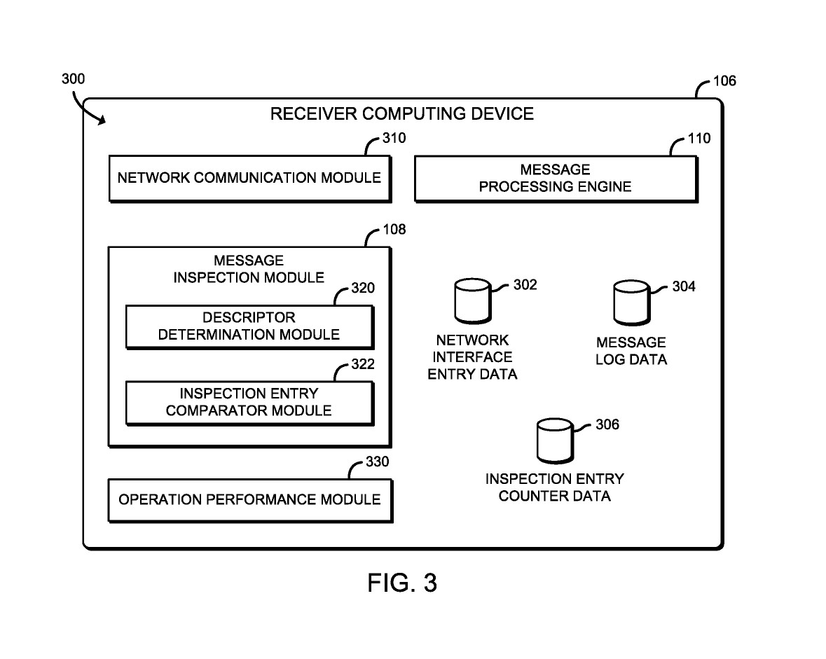

Referring now to FIG. 3, in an illustrative embodiment, the receiver computing device 106 establishes an environment 300 during operation. The illustrative environment 300 includes a network communication module 310 and an operation performance module 330, as well as the message inspection module 108 and the message processing engine 110 of FIG. 1. Each of the modules, logic, and other components of the environment 300 may be embodied as hardware, software, firmware, or a combination thereof. For example, each of the modules, logic, and other components of the environment 300 may form a portion of, or otherwise be established by, the CPU 202 or other hardware components of the receiver computing device 106. As such, in some embodiments, one or more of the modules of the environment 300 may be embodied as a circuit or collection of electrical devices (e.g., network communication circuitry 310, operation performance circuitry 330, message inspection circuitry 108, message processing circuitry 110, etc.).

In the illustrative environment 300, the receiver computing device 106 includes network port entry data 302, message log data 304, and inspection entry counter data 306, each of which may be accessed by the various modules and/or sub-modules of the receiver computing device 106. It should be appreciated that the receiver computing device 106 may include other components, sub-components, modules, sub-modules, and/or devices commonly found in a network device, which are not illustrated in FIG. 3 for clarity of the description.

The network communication module 310 is configured to facilitate inbound and outbound network communications (e.g., network traffic, network packets, network flows, etc.) to and from the receiver computing device 106. To do so, the network communication module 310 is configured to receive and process network packets from other computing devices (e.g., the source computing devices 102 or another computing device communicatively coupled via the network 104). Additionally, the network communication module 310 is configured to prepare and transmit network packets to another computing device (e.g., the source computing devices 102 or another computing device communicatively coupled via the network 104). Accordingly, in some embodiments, at least a portion of the functionality of the network communication module 310 may be performed by the communication circuitry 210, and more specifically by the NIC 212.

As described previously, the message inspection module 108 is configured to inspect and filter received messages prior to the received messages being processed by other message processing technologies that can alter application state, such as the message processing performed by the message processing engine 110. To do so, the message inspection module 108 may be located on the receive message path in a downstream position of the lower layer processing. In other words, a deep packet inspection (DPI) is not necessary to perform the inspection and filtering, as the lower network layers have already been stripped from the message. Accordingly, the message inspection module 108 only needs to inspect relevant information. To do so, the illustrative message inspection module 108 includes a descriptor determination module 320 and an inspection entry comparator module 322.

The descriptor determination module 320 is configured to determine a descriptor of a received message (i.e., match criteria of the received message). The descriptor may be embodied as, or otherwise include, any type of data that is indicative of a characteristic of the message, or a characteristic of a series of messages (e.g., a network flow), and is capable of being retrieved from the message without modifying the present state of the receiver computing device 106. For example, the descriptor may be embodied as data contained in a header of the message that is indicative of a characteristic of that message, such as one or more “match” bits, a sender of the message, a size of the message, a destination computing device of the message, a tag associated with the message, and/or any other message header information. Accordingly, the descriptor determination module 320 is configured to retrieve at least a portion of the message header for inspection.

The inspection entry comparator module 322 is configured to retrieve a set of network port entries (e.g., from a table such as the table 400 of network port entries 402 of FIG. 4, a linked-list, or other data construct) based on a logical network port (e.g., of the NIC 212) that received the message. In some embodiments, the network port entries may be retrieved from the network port entry data 302. Each of the network port entries may include one or more inspection entries (see, e.g., the inspection entry 406 of FIG. 4) that each includes a descriptor of the inspection entry and an operation that may be performed by the receiver computing device 106. Each inspection entry may be associated with a particular service, port, or network port entry of the table or other data construct. As described below, the descriptor of the inspection entry is compared against the descriptor of the received message (e.g., as determined by the descriptor determination module 320).

Accordingly, the descriptor of the inspection entry corresponds to a characteristic of a message, such as one or more “match” bits (e.g., descriptors of the message), a sender, a size, a destination, a tag, and/or any other information that may be stored in a header of a received message. Additionally or alternatively, each of the network port entries may include one or more match list entries (see, e.g., the match list entries 408 of FIG. 4) that each similarly includes a descriptor of the respective match list entry (i.e., match criteria of the match list entry) and an operation to be performed by the receiver computing device 106 upon matching the descriptor of the message with the descriptor of the match list entry.

The inspection entry comparator module 322 is further configured to determine whether the descriptor of the received message matches the descriptor of the inspection entry. To do so, the inspection entry comparator module 322 is configured to compare the descriptor of the received message against the descriptor of the inspection entry. For example, in some embodiments, the inspection entry comparator module 322 may compare a set of “match” bits retrieved from the received message to a set of “match” bits of the inspection entry. As described below, upon determining a match, the inspection entry comparator module 322 may provide a notification to the receiver computing device 106 (e.g., the operator performance module 330) that indicates to the receiver computing device 106 of an operation corresponding to the matching inspection entry.

Accordingly, the operation performance module 330 is configured to receive the notification and perform the operation of the matching inspection entry based on the received notification. In some embodiments, performing the operation of the inspection entry may include dropping the message or sending the message to the message processing engine for further processing (i.e., further processing that can alter state of the receiver computing device 106). Additionally or alternatively, a notification may be sent to the sender (e.g., one of the sender computing devices 102) of a status of the message, the message may be logged, a counter may be incremented to reflect the message was dropped or permitted to be further processed, etc. In such embodiments wherein at least a portion of the message is logged, the logged data (e.g., a sender, a destination, a tag, match bits, etc.) may be stored in the message log data 304. In such embodiments wherein a counter is incremented, the counter data may be stored in the inspection entry counter data 306.

Referring now to FIG. 4, an illustrative implementation includes a table 400 of network port entries 402 for directing message delivery of a logical network port. Such network port entries 402 can be used, for example, in Message Passing Interface (MPI) communication protocol to steer incoming messages on a given logical network port to a correct memory buffer. Each of the match list entries 408 may describe one such memory buffer set up by the application. For example, in an embodiment using the Portals 4.0 Network Programming Interface, the table 400 may be a portal table that includes a number of lists associated with each of the network port entries, such as the priority list 404 and the overflow list 410 shown in FIG. 4. It should be appreciated that, in some embodiments, alternative and/or additional or fewer elements may be available in other implementations (e.g., an event queue, an unexpected list, etc.).

In such an embodiment employing the Portals 4 interface, a plurality of portal tables may be used, wherein each portal table corresponds to a different logical network port and each network port entry is accessible via an index of the network port entry. Accordingly, in such embodiments, an index may be selected based on a location at which data associated with the message is to be written (e.g., an address range) upon subsequent processing of the message (e.g., processing of the message at the message processing engine 110). It should be appreciated that one or more logical network ports may be associated with a single physical networking interface.

Each of the network port entries 402 (e.g., the highlighted second entry from the top of the table 400) may be accessed based on an index of the table 400 that corresponds to one of the network port entries 402. As described previously, each of the network port entries 402 may include one or more inspection entries 406 that may be traversed by the message inspection module 108 and one or more match list entries 408 that may be traversed by the message processing engine 110. As shown in FIG. 4, the illustrative inspection entry 406 includes a descriptor 412 for matching against and an operation 414 which describes the action to be performed upon matching the descriptor 412.

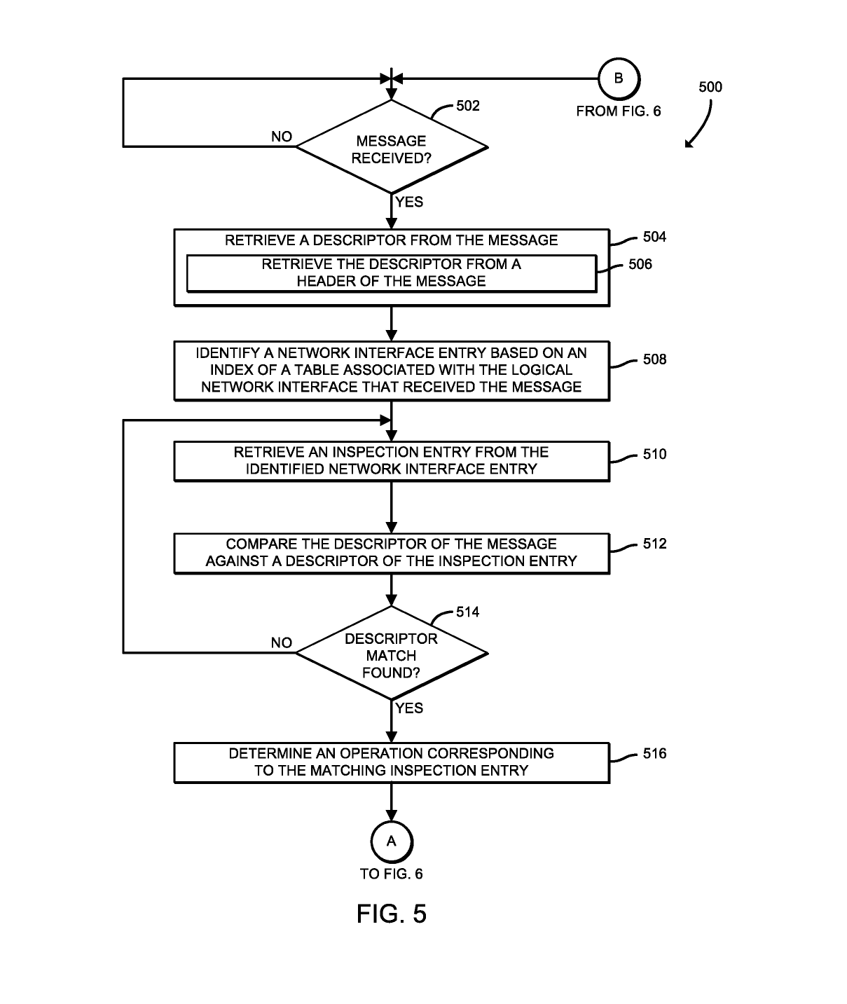

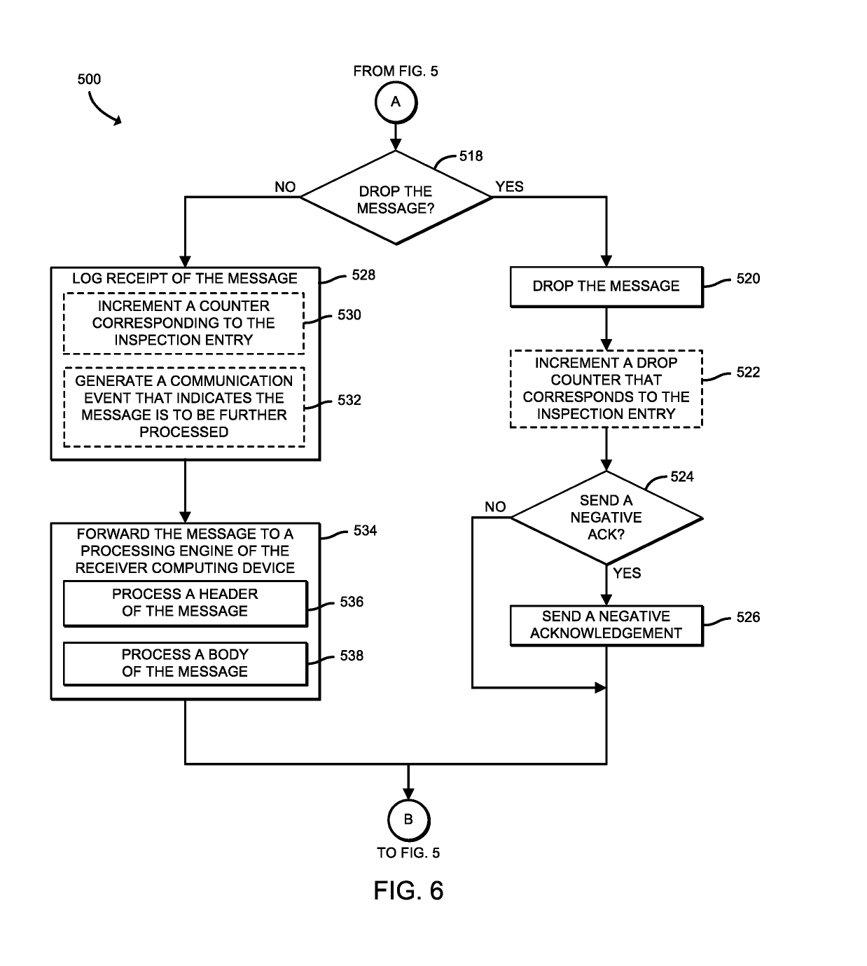

Referring now to FIGS. 5 and 6, in use, the receiver computing device 106 may execute a method 500 for filtering received messages. It should be appreciated that at least a portion of the method 500 may be offloaded to and executed by the message inspection module 108 of the receiver computing device 106 prior to any processing of the message that may result in a state change of the receiver computing device 106 (e.g., message processing at the message processing engine 110). The method 500 begins with block 502, in which the receiver computing device 106 determines whether a message was received. If not, the method loops back to block 502 to continue to monitor for a received message. Otherwise, if the message was received, the method 500 advances to block 504.

In block 504, the receiver computing device 106 (e.g., the message inspection module 108) retrieves a descriptor from the received message. To do so, the receiver computing device 106, in block 506, retrieves the descriptor from a header of the message. It should be appreciated that, in some embodiments, more than one field, or tag, of the header of the message may be retrieved by the receiver computing device 106. As described previously, the descriptor of the received message may be embodied as, or otherwise include, any type of data indicative of a characteristic of the message, or a characteristic of a series of messages (e.g., a network flow), such as one or more “match” bits, a sender of the message, a size of the message, a destination computing device of the message, a tag associated with the message, and/or any other information, which may be included in the header of the received message, in some embodiments.

In block 508, the receiver computing device 106 identifies a network port entry (e.g., one of the network port entries 402 of FIG. 4) based on an index of a network port entry table or other data structure (e.g., the table 400 of FIG. 4) associated with a logical network port that received the message. In block 510, the receiver computing device 106 retrieves an inspection entry from the network port entry identified in block 508. In block 512, the receiver computing device 106 compares the descriptor of the message retrieved in block 504 against a descriptor of the inspection entry. In bock 514, the receiver computing device 106 determines whether the descriptor of the message matches the descriptor of the inspection entry. If not, the method 500 loops back to block 510 to retrieve another inspection entry from the network port entry identified in block 508. Otherwise, if the receiver computing device 106 determines the descriptor of the message does match the descriptor of the inspection entry, the method 500 advances to block 516.

In block 516, the receiver computing device 106 determines an operation corresponding to the matching inspection entry before advancing to block 518 of FIG. 6. In some embodiments, the operation may be included in the matching inspection entry. It should be appreciated that, in some embodiments, the method 500 may continue to perform the actions of blocks 510, 512, 514, and 516 until all of the inspection entries have been checked against before proceeding to block 518.

In block 518, the receiver computing device 106 determines whether the operation corresponding to the matching inspection entry includes dropping the message received at block 502. For example, the operation may include a drop action (e.g., drop) or a drop and acknowledge action (e.g., drop and NACK). If the operation corresponding to the matching inspection entry includes dropping the message, the method 500 advances to block 520. In block 520, the receiver computing device 106 drops the message. In some embodiments, the message may be dropped silently, such that the dropping of the message may be used for fault tolerance when messages simply need to be dropped. In some embodiments, in block 522, the receiver computing device 106 may increment a counter (e.g., a drop counter) corresponding to the inspection entry to track a number of dropped packets associated with the inspection entry.

In block 524, the receiver computing device 106 determines whether to send a negative acknowledgement to the sender computing device 102 that sent the message received at the receiver computing device 106 in block 502. If the receiver computing device 106 determines the negative acknowledgement is to be sent, the method 500 advances to block 526, wherein the receiver computing device 106 sends the negative acknowledgement before returning to block 502 to determine whether another message was received. In such embodiments, the notification to the sender of the message may include information usable by the sender for user-level flow control, quality of service monitoring, etc. Otherwise, if the receiver computing device 106 determines the negative acknowledgement is not to be sent, the method 500 returns to block 502 to determine whether another message was received.

If the receiver computing device 106, in block 518, determines the operation corresponding to the matching inspection entry does not include dropping the message received at block 502, the method 500 advances to block 528. In block 528, the receiver computing device 106 logs that the message was received. To do so, in block 530, in some embodiments, the receiver computing device 106 may increment a counter corresponding to the inspection entry. Additionally or alternatively, in block 532, in some embodiments, the receiver computing device 106 may generate a communication event that indicates the message is to be further processed.

In block 534, the receiver computing device 106 forwards the message to the message processing engine 110 for further processing of the message. To do so, in block 536, the receiver computing device 106 processes a header (e.g., one or more header fields) of the message received at block 502. Additionally or alternatively, in block 538, the receiver computing device 106 processes a body of the message before the method 500 returns to block 502 to determine whether another message was received.

### EXAMPLES

Illustrative examples of the technologies disclosed herein are provided below. An embodiment of the technologies may include any one or more, and any combination of, the examples described below.

Example 1 includes a computing device to filter a received message, the computing device comprising a network interface controller comprising a data storage device having stored therein a plurality of instructions that, when executed by the network interface controller, causes the network interface controller to receive a message to be processed by the computing device from a sender computing device communicatively coupled to the computing device; retrieve, prior to processing the message by a message processing engine of the computing device, a first descriptor from the message; determine a network port entry of a list of network port entries to compare the first descriptor of the received message to, wherein the network port entry includes one or more inspection entries, and wherein each of the inspection entries includes a second descriptor and an operation to be performed by the computing device; determine whether the first descriptor of the message matches the second descriptor of one of the inspection entries; and perform, in response to a determination that the first descriptor of the message matches the second descriptor of the one of the inspection entries, the operation of the one of the inspection entries whose second descriptor matches the first descriptor of the message.

Example 2 includes the subject matter of Example 1, and wherein to receive the message to be processed by the computing device from a sender computing device communicatively coupled to the computing device comprises to receive the message by a logical network port of a network interface controller of the computing device.

Example 3 includes the subject matter of any of Examples 1 and 2, and wherein to determine the network port entry of the list of network port entries comprises to retrieve the list of network port entries based on the logical network port that received the message and addressing information of the received message.

Example 4 includes the subject matter of any of Examples 1-3, and wherein to perform the operation on the message comprises to drop the message in response to a determination that the operation corresponds to dropping the message.

Example 5 includes the subject matter of any of Examples 1-4, and wherein to perform the operation on the message further comprises to send a negative acknowledgment to the sender computing device in response to a determination that the operation further corresponds to sending a negative acknowledgement.

Example 6 includes the subject matter of any of Examples 1-5, and wherein to perform the operation on the message comprises to log a receipt of the message in response to a determination that the operation corresponds to continuing to process the message.

Example 7 includes the subject matter of any of Examples 1-6, and wherein to log the receipt of the message comprises to increment a counter corresponding to the one of the inspection entries whose second descriptor matches the first descriptor of the message.

Example 8 includes the subject matter of any of Examples 1-7, and wherein to log the receipt of the message comprises to generate a communication event indicating the message was received and that processing of the message is to continue.

Example 9 includes the subject matter of any of Examples 1-8, and wherein to perform the operation on the message comprises to forward the message to the message processing engine of the computing device.

Example 10 includes the subject matter of any of Examples 1-9, and wherein to forward the message to the message processing engine comprises to process a header of the message to update a state of the computing device.

Example 11 includes the subject matter of any of Examples 1-10, and wherein to forward the message to the message processing engine comprises to process at least one of a header of the message and a body of the message by the message processing engine of the computing device.

Example 12 includes the subject matter of any of Examples 1-11, and further comprising a system-on-a-chip (SoC) that includes one or more processors and the network interface controller.

Example 13 includes the subject matter of any of Examples 1-12, and further comprising a multichip package that includes one or more processors and the network interface controller.

Example 14 includes a method for filtering a received message, the method comprising receiving, by a computing device, a message to be processed by the computing device from a sender computing device communicatively coupled to the computing device; retrieving, by the computing device and prior to processing the message, a first descriptor from the message; determining, by the computing device, a network port entry of a list of network port entries to compare the first descriptor of the received message to, wherein the network port entry includes one or more inspection entries, and wherein each of the inspection entries includes a second descriptor and an operation to be performed by the computing device; determining, by the computing device, whether the first descriptor of the message matches the second descriptor of one of the inspection entries; and performing, by the computing device and in response to a determination that the first descriptor of the message matches the second descriptor of the one of the inspection entries, the operation of the one of the inspection entries whose second descriptor matches the first descriptor of the message.

Example 15 includes the subject matter of Example 14, and wherein receiving the message to be processed by the computing device from a sender computing device communicatively coupled to the computing device comprises receiving the message by a logical network port of a network interface controller of the computing device.

Example 16 includes the subject matter of any of Examples 14 and 15, and wherein determining the network port entry of the list of network port entries comprises retrieving the list of network port entries based on the logical network port that received the message and addressing information of the received message.

Example 17 includes the subject matter of any of Examples 14-16, and wherein performing the operation on the message comprises dropping the message in response to a determination that the operation corresponds to dropping the message.

Example 18 includes the subject matter of any of Examples 14-17, and wherein performing the operation on the message further comprises sending a negative acknowledgment to the sender computing device in response to a determination that the operation further corresponds to sending a negative acknowledgement.

Example 19 includes the subject matter of any of Examples 14-18, and wherein performing the operation on the message comprises logging a receipt of the message in response to a determination that the operation corresponds to continuing to process the message.

Example 20 includes the subject matter of any of Examples 14-19, and wherein logging the receipt of the message comprises incrementing a counter corresponding to the one of the inspection entries whose second descriptor matches the first descriptor of the message.

Example 21 includes the subject matter of any of Examples 14-20, and wherein logging the receipt of the message comprises generating a communication event indicating the message was received and that processing of the message is to continue.

Example 22 includes the subject matter of any of Examples 14-21, and wherein performing the operation on the message comprises forwarding the message to the message processing engine of the computing device.

Example 23 includes the subject matter of any of Examples 14-22, and wherein forwarding the message to the message processing engine comprises processing a header of the message to update a state of the computing device.

Example 24 includes the subject matter of any of Examples 14-23, and wherein forwarding the message to the message processing engine comprises processing at least one of a header of the message and a body of the message by the message processing engine of the computing device.

Example 25 includes a computing device comprising a processor; and a memory having stored therein a plurality of instructions that when executed by the processor cause the computing device to perform the method of any of Examples 14-24.

Example 26 includes one or more machine readable storage media comprising a plurality of instructions stored thereon that in response to being executed result in a computing device performing the method of any of Examples 14-24.

Example 27 includes a computing device to filter a received message, the computing device comprising network communication circuitry to receive a message to be processed by the computing device from a sender computing device communicatively coupled to the computing device; message inspection circuitry to (i) retrieve, prior to processing the message by a message processing engine of the computing device, a first descriptor from the message, (ii) determine a network port entry of a list of network port entries to compare the first descriptor of the received message to, wherein the network port entry includes one or more inspection entries, and wherein each of the inspection entries includes a second descriptor and an operation to be performed by the computing device, and (iii) determine whether the first descriptor of the message matches the second descriptor of one of the inspection entries; and operation performance circuitry to perform, in response to a determination that the first descriptor of the message matches the second descriptor of the one of the inspection entries, the operation of the one of the inspection entries whose second descriptor matches the first descriptor of the message.

Example 28 includes the subject matter of Example 27, and wherein to receive the message to be processed by the computing device from a sender computing device communicatively coupled to the computing device comprises to receive the message by a logical network port of a network interface controller of the computing device.

Example 29 includes the subject matter of any of Examples 27 and 28, and wherein to determine the network port entry of the list of network port entries comprises to retrieve the list of network port entries based on the logical network port that received the message and addressing information of the received message.

Example 30 includes the subject matter of any of Examples 27-29, and wherein to perform the operation on the message comprises to drop the message in response to a determination that the operation corresponds to dropping the message.

Example 31 includes the subject matter of any of Examples 27-30, and wherein to perform the operation on the message further comprises to send a negative acknowledgment to the sender computing device in response to a determination that the operation further corresponds to sending a negative acknowledgement.

Example 32 includes the subject matter of any of Examples 27-31, and wherein to perform the operation on the message comprises to log a receipt of the message in response to a determination that the operation corresponds to continuing to process the message.

Example 33 includes the subject matter of any of Examples 27-32, and wherein to log the receipt of the message comprises to increment a counter corresponding to the one of the inspection entries whose second descriptor matches the first descriptor of the message.

Example 34 includes the subject matter of any of Examples 27-33, and wherein to log the receipt of the message comprises to generate a communication event indicating the message was received and that processing of the message is to continue.

Example 35 includes the subject matter of any of Examples 27-34, and wherein to perform the operation on the message comprises to forward the message to the message processing engine of the computing device.

Example 36 includes the subject matter of any of Examples 27-35, and wherein to forward the message to the message processing engine comprises to process a header of the message to update a state of the computing device.

Example 37 includes the subject matter of any of Examples 27-36, and wherein to forward the message to the message processing engine comprises to process at least one of a header of the message and a body of the message by the message processing engine of the computing device.

Example 38 includes a computing device to filter a received message, the computing device comprising means for receiving a message to be processed by the computing device from a sender computing device communicatively coupled to the computing device; means for retrieving, prior to processing the message, a first descriptor from the message; means for determining a network port entry of a list of network port entries to compare the first descriptor of the received message to, wherein the network port entry includes one or more inspection entries, and wherein each of the inspection entries includes a second descriptor and an operation to be performed by the computing device; means for determining whether the first descriptor of the message matches the second descriptor of one of the inspection entries; and means for performing, in response to a determination that the first descriptor of the message matches the second descriptor of the one of the inspection entries, the operation of the one of the inspection entries whose second descriptor matches the first descriptor of the message.

Example 39 includes the subject matter of Example 38, and wherein the means for receiving the message to be processed by the computing device from a sender computing device communicatively coupled to the computing device comprises means for receiving the message by a logical network port of a network interface controller of the computing device.

Example 40 includes the subject matter of any of Examples 38 and 39, and wherein the means for determining the network port entry of the list of network port entries comprises means for retrieving the list of network port entries based on the logical network port that received the message and addressing information of the received message.

Example 41 includes the subject matter of any of Examples 38-40, and wherein the means for performing the operation on the message comprises means for dropping the message in response to a determination that the operation corresponds to dropping the message.

Example 42 includes the subject matter of any of Examples 38-41, and wherein the means for performing the operation on the message further comprises means for sending a negative acknowledgment to the sender computing device in response to a determination that the operation further corresponds to sending a negative acknowledgement.

Example 43 includes the subject matter of any of Examples 38-42, and wherein the means for performing the operation on the message comprises means for logging a receipt of the message in response to a determination that the operation corresponds to continuing to process the message.

Example 44 includes the subject matter of any of Examples 38-43, and wherein the means for logging the receipt of the message comprises means for incrementing a counter corresponding to the one of the inspection entries whose second descriptor matches the first descriptor of the message.

Example 45 includes the subject matter of any of Examples 38-44, and wherein the means for logging the receipt of the message comprises means for generating a communication event indicating the message was received and that processing of the message is to continue.

Example 46 includes the subject matter of any of Examples 38-45, and wherein the means for performing the operation on the message comprises means for forwarding the message to the message processing engine of the computing device.

Example 47 includes the subject matter of any of Examples 38-46, and wherein the means for forwarding the message to the message processing engine comprises means for processing a header of the message to update a state of the computing device.

Example 48 includes the subject matter of any of Examples 38-47, and wherein the means for forwarding the message to the message processing engine comprises means for processing at least one of a header of the message and a body of the message by the message processing engine of the computing device.

1. A computing device to filter a received message, the computing device comprising:
a network interface controller comprising a data storage device having stored therein a plurality of instructions that, when executed by the network interface controller, causes the network interface controller to:
receive a message to be processed by the computing device from a sender computing device communicatively coupled to the computing device;
retrieve, prior to processing the message by a message processing engine of the computing device, a first descriptor from the message;
determine a network port entry of a list of network port entries, wherein the network port entry includes one or more inspection entries, and wherein each of the inspection entries includes a second descriptor and an operation to be performed by the computing device;
determine whether the first descriptor of the message matches the second descriptor of one of the inspection entries; and
perform, in response to a determination that the first descriptor of the message matches the second descriptor of the one of the inspection entries, the operation of the one of the inspection entries whose second descriptor matches the first descriptor of the message.

2. The computing device of claim 1, wherein to receive the message to be processed by the computing device from a sender computing device communicatively coupled to the computing device comprises to receive the message by a logical network port of the network interface controller of the computing device.

3. The computing device of claim 2, wherein to determine the network port entry of the list of network port entries comprises to retrieve the list of network port entries based on the logical network port that received the message and addressing information of the received message.

4. The computing device of claim 1, wherein to perform the operation on the message comprises to drop the message in response to a determination that the operation corresponds to dropping the message.

5. The computing device of claim 4, wherein to perform the operation on the message further comprises to send a negative acknowledgment to the sender computing device in response to a determination that the operation further corresponds to sending a negative acknowledgement.

6. The computing device of claim 1, wherein to perform the operation on the message comprises to log a receipt of the message in response to a determination that the operation corresponds to continuing to process the message.

7. The computing device of claim 6, wherein to log the receipt of the message comprises to at least one of increment a counter corresponding to the one of the inspection entries whose second descriptor matches the first descriptor of the message and generate a communication event indicating the message was received and that processing of the message is to continue.

8. The computing device of claim 1, wherein to perform the operation on the message comprises to forward the message to the message processing engine of the computing device.

9. The computing device of claim 9, wherein to forward the message to the message processing engine comprises to process at least one of a header of the message and a body of the message by the message processing engine of the computing device and to update a state of the computing device as a function of the message having been processed.

10. The computing device of claim 9, further comprising a system-on-a-chip (SoC) that includes one or more processors and the network interface controller.

11. The computing device of claim 9, further comprising a multichip package that includes one or more processors and the network interface controller.

12. One or more computer-readable storage media comprising a plurality of instructions stored thereon that in response to being executed cause a computing device to:
receive a message to be processed by the computing device from a sender computing device communicatively coupled to the computing device;
retrieve, prior to processing the message by a message processing engine of the computing device, a first descriptor from the message;
determine a network port entry of a list of network port entries to compare the first descriptor of the received message to, wherein the network port entry includes one or more inspection entries, and wherein each of the inspection entries includes a second descriptor and an operation to be performed by the computing device;
determine whether the first descriptor of the message matches the second descriptor of one of the inspection entries; and
perform, in response to a determination that the first descriptor of the message matches the second descriptor of the one of the inspection entries, the operation of the one of the inspection entries whose second descriptor matches the first descriptor of the message.

13. The one or more computer-readable storage media of claim 12, wherein to receive the message to be processed by the computing device from a sender computing device communicatively coupled to the computing device comprises to receive the message by a logical network port of a network interface controller of the computing device.

14. The one or more computer-readable storage media of claim 13, wherein to determine the network port entry of the list of network port entries comprises to retrieve the list of network port entries based on the logical network port that received the message and addressing information of the received message.

15. The one or more computer-readable storage media of claim 12, wherein to perform the operation on the message comprises to drop the message in response to a determination that the operation corresponds to dropping the message.

16. The computing device of claim 15, wherein to perform the operation on the message further comprises to send a negative acknowledgment to the sender computing device in response to a determination that the operation further corresponds to sending a negative acknowledgement.

17. The one or more computer-readable storage media of claim 12, wherein to perform the operation on the message comprises to log a receipt of the message in response to a determination that the operation corresponds to continuing to process the message.

18. The one or more computer-readable storage media of claim 17, wherein to log the receipt of the message comprises to at least one of increment a counter corresponding to the one of the inspection entries whose second descriptor matches the first descriptor of the message and generate a communication event indicating the message was received and that processing of the message is to continue.

19. The one or more computer-readable storage media of claim 12, wherein to perform the operation on the message comprises to forward the message to the message processing engine of the computing device.

20. The one or more computer-readable storage media of claim 20, wherein to forward the message to the message processing engine comprises to process at least one of a header of the message and a body of the message by the message processing engine of the computing device and update a state of the computing device as a function of the message being processed.

21. A method for filtering a received message, the method comprising:
receiving, by a computing device, a message to be processed by the computing device from a sender computing device communicatively coupled to the computing device;
retrieving, by the computing device and prior to processing the message, a first descriptor from the message;
determining, by the computing device, a network port entry of a list of network port entries to compare the first descriptor of the received message to, wherein the network port entry includes one or more inspection entries, and wherein each of the inspection entries includes a second descriptor and an operation to be performed by the computing device;
determining, by the computing device, whether the first descriptor of the message matches the second descriptor of one of the inspection entries; and
performing, by the computing device and in response to a determination that the first descriptor of the message matches the second descriptor of the one of the inspection entries, the operation of the one of the inspection entries whose second descriptor matches the first descriptor of the message.

22. The method of claim 21, wherein receiving the message to be processed by the computing device from a sender computing device communicatively coupled to the computing device comprises receiving the message by a logical network port of a network interface controller of the computing device, and wherein determining the network port entry of the list of network port entries comprises retrieving the list of network port entries based on the logical network port that received the message and addressing information of the received message.

23. The method of claim 21, wherein performing the operation on the message comprises dropping the message in response to a determination that the operation corresponds to dropping the message and sending a negative acknowledgment to the sender computing device in response to a determination that the operation further corresponds to sending a negative acknowledgement.

24. A computing device to filter a received message, the computing device comprising:
network communication circuitry to receive a message to be processed by the computing device from a sender computing device communicatively coupled to the computing device;
means for retrieving, prior to processing the message, a first descriptor from the message;
means for determining a network port entry of a list of network port entries to compare the first descriptor of the received message to, wherein the network port entry includes one or more inspection entries, and wherein each of the inspection entries includes a second descriptor and an operation to be performed by the computing device;
means for determining whether the first descriptor of the message matches the second descriptor of one of the inspection entries; and
means for performing, in response to a determination that the first descriptor of the message matches the second descriptor of the one of the inspection entries, the operation of the one of the inspection entries whose second descriptor matches the first descriptor of the message.

25. The computing device of claim 24, wherein the means for performing the operation on the message comprises means for dropping the message in response to a determination that the operation corresponds to dropping the message and sending a negative acknowledgment to the sender computing device in response to a determination that the operation further corresponds to sending, or logging, a receipt of the message and forwarding the message to the message processing engine of the computing device in response to a determination that the operation corresponds to continuing to process the message.
